(19) United States
(12) Patent Application Publication
(10) Pub. No.: US 2013/0297823 A1
(43) Pub. Date: Nov. 7, 2013

(54) SECURE DEVICE PAIRING INITIATION VIA WIDE AREA NETWORK

(71) Applicant: Thomas HERBST, Atherton, CA (US)

(72) Inventor: Thomas HERBST, Atherton, CA (US)

(21) Appl. No.: 13/466,053

(22) Filed: May 7, 2012

(51) Int. Cl. G06F 15/16; G06F 3/01

(52) U.S. Cl. 709/237

(57) ABSTRACT

A method of operating a communication device includes, by the communication device, receiving a handshake initiation indication provided to the communication device via a wide area network. Based at least in part on the received handshake initiation indication, causing the communication device to enter a handshake mode. Based on the communication device having entered the handshake mode, autonomously operating the communication device in conjunction with a second device to configure the communication device for secure communication with the second device, wherein the communication device is further configured for routing data between at least a third device and the second device, via the wide area network and via the thus-configured secure communication between the communication device and the second device.

### TECHNICAL FIELD

The present application relates to secure pairing of network devices and, in particular, to a method by which a “push button” of a device in a physically non-secure location may activated by a secure wide area network communication link to the device.

### BACKGROUND

Push-button pairing of network devices is known. For example, this push-button pairing function is available with many conventional WiFi routers. When a physical button is pressed by a user on both an access point device and on a client device, the two devices may exchange security keys so that the two devices are configured to communicate with each other securely (such as using WPA-level security).

### SUMMARY

In accordance with one aspect, a method of operating a communication device includes, by the communication device, receiving a handshake initiation indication provided to the communication device via a wide area network. Based at least in part on the received handshake initiation indication, causing the communication device to enter a handshake mode. Based on the communication device having entered the handshake mode, autonomously operating the communication device in conjunction with a second device to configure the communication device for secure communication with the second device, wherein the communication device is further configured for routing data between at least a third device and the second device, via the wide area network and via the thus-configured secure communication between the communication device and the second device.

### BRIEF DESCRIPTION OF THE DRAWINGS

FIG. 1 is a block diagram of a system illustrating an example of secure pairing functionality may be achieved by using a “virtual” push button, accessible via secure means such as by a utility's customer portal.

FIG. 2 is an example user interface display via which a user may interact with the secure pairing functionality.

### DETAILED DESCRIPTION

The conventional push-button pairing of network devices operate under the assumption that, for example, both the access point device and the client device to be paired are located in a physically secure location. In other words, only authorized users would have physical access to the devices to push the buttons and initiate pairing of the devices. For example, an access point may be located inside a house or business.

However, for Home Area Networks usable for monitoring and controlling energy usage, the access point is typically in a location that is not physically secure, such as the physical exterior of a customer premise (e.g., mounted on the outside of a house), incorporated within an electric meter.

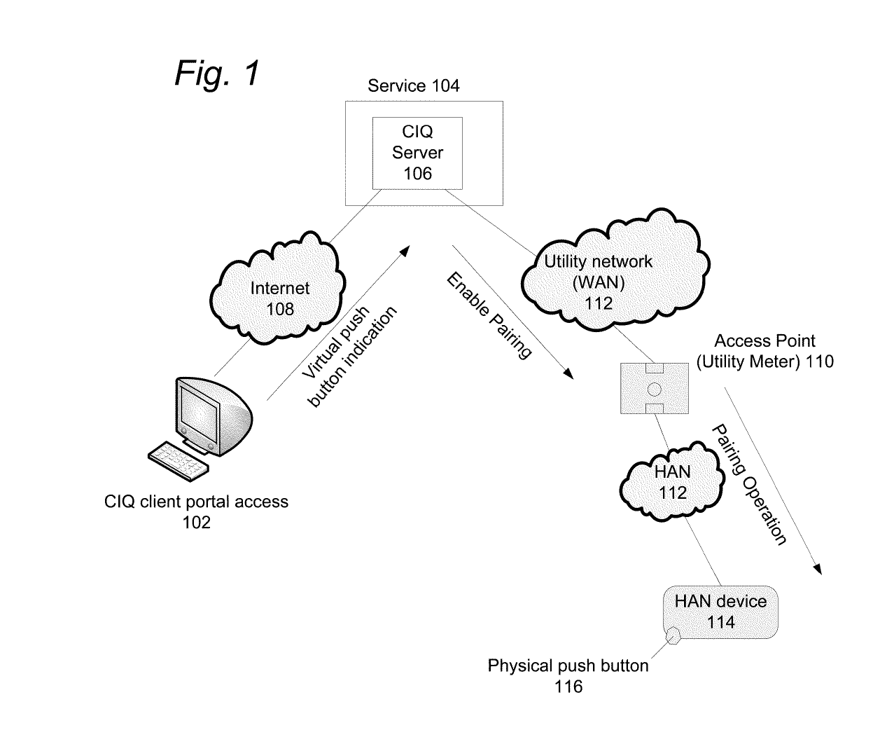

The inventors have realized that a secure pairing functionality may be achieved by using a “virtual” push button, accessible via secure means such as by a utility's customer portal. Referring to FIG. 1, one such utility customer portal 102 is powered by the CustomerIQ™ product of Silver Spring Networks, Inc., Redwood City, Calif. More particularly, the CustomerIQ product is a utility customer facing web portal, via which utility customers may interact with a service 104, operating on one or more servers 106, that maintains and processes data about the customer's energy usage. Such interaction is via one or more networks such as the internet 108. The data about the customer's energy usage typically includes data that has been collected from the customer's energy meter 110.

Such collection may be controlled by a “back office server” via a secure connection over one or more utility networks 112 including a mesh network of energy meters. See, for example, United States Patent Application Publication 20090245270, which illustrates such networks. In accordance with an aspect of the invention, a secure connection between the back office server and a particular energy meter may be made selectively available to functions of a utility customer portal such as the CustomerIQ web portal. More specifically, in accordance with an aspect, the secure connection is usable to enable access by the utility customer to a “virtual push button” of that customer's utility meter 110, to initiate secure pairing of the meter 110 via a HAN 112 with a HAN device 114.

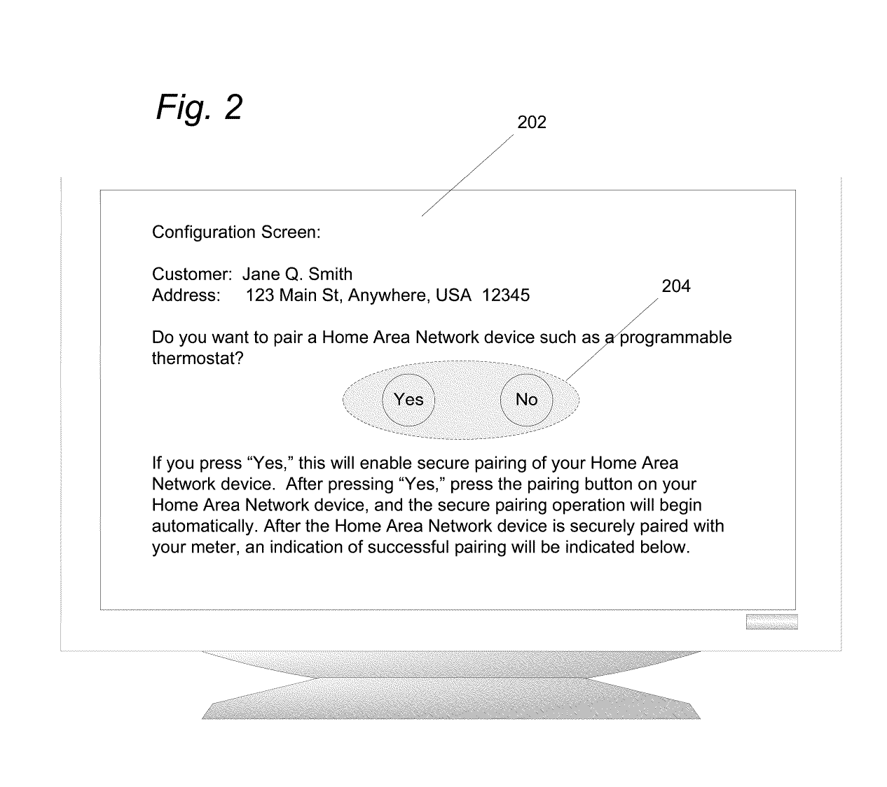

For example, referring to FIG. 2, a display 202 of the customer web portal may include a graphical user interface object 204 representing functionality of a physical push button, to enable pairing of the meter (as an access point or containing an access point) with a HAN device for use in the home (e.g., a thermostat, etc.). More specifically, in accordance with an aspect, the “push button” interface object 204 of the meter is virtually activated, using a secure network link, from the service with which the web portal interacts, to the meter. Access to the virtual push button 204 is secured, such as by password-limited access (e.g., via HTTPS or other secure connection) to the web portal, as is the network link between the web portal service and the access point.

As a result of particular customer interaction with the back-office service via the secure link (e.g., activating a virtual button on the back-office service customer portal), the back office service then securely interacts with the meter. More particularly, the back office service securely interacts with the meter to configure the meter for secure pairing with a HAN device—typically by functionality similar to what would occur conventionally when a user physically presses a button on the access point. The HAN device itself would generally be so enabled for secure pairing using a physical push button but, in some examples, is enabled using a software push button—such as if the HAN device is directly connected to a computer for configuration.

While the foregoing is directed to embodiments of the present invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present invention, are embodiments of the present invention.

What is claimed is:

1. A method of operating a communication device, comprising:
by the communication device, receiving a handshake initiation indication provided to the communication device via a wide area network;
based at least in part on the received handshake initiation indication, causing the communication device to enter a handshake mode; and
based on the communication device having entered the handshake mode, autonomously operating the communication device in conjunction with a second device to configure the communication device for secure communication with the second device, wherein the communication device is further configured for routing data between at least a third device and the second device, via the wide area network and via the thus-configured secure communication between the communication device and the second device.

2. The method of claim 1, wherein the communication device is an access point connected for routing data between the wide area network and devices, including the second device, within a home area network.

3. The method of claim 1, wherein the communication device is an access point within a utility meter, the wide area network includes a mesh network of utility meters, and the secure communication between the access point and the second device is within a home area network.

4. A method of providing a utility-related portal, comprising:
operating a computing device to, by the computing device, cause display of a user interface, including causing display of a graphical user interface object;
operating the computing device to, by the computing device, receive an indication that a user has activated, via a user interface to a computing device, the graphical user interface object;
operating the computing device to, based on the computing device receiving the indication that the user has activated the graphical user interface, the computing device causes a handshake initiation indication to be provided to a communication device via a wide area network,
wherein the communication device enters a handshake mode in response to receiving the handshake indication, to autonomously operate the communication device in conjunction with a second device to configure the communication device for secure communication with the second device, including configuring the communication device for routing data between at least a third device and the second device, via the wide area network and via the secure communication between the communication device and the second device.

5. The method of claim 4, wherein:
the user interface is a user interface of a web portal configured for a utility customer to access information related to utility usage by the utility customer.

6. A communication device, comprising:
circuitry to connect the communication device to a wide area network;
circuitry configured to receive, via a wide area network, a handshake initiation indication for the communication device, wherein the communication device is configured to enter a handshake mode in response to receiving the handshake indication, to autonomously operate the communication device in conjunction with a second device to configure the communication device for secure communication with the second device, including configuring the communication device for routing data between at least a third device and the second device, via the wide area network and via the secure communication between the communication device and the second device.

7. The communication device of claim 6, wherein:
the communication device is configured for routing data between the wide area network and devices, including the second device, within a home area network.

8. The communication device of claim 6, wherein:
the communication device is an access point within a utility meter, the wide area network includes a mesh network of utility meters, and the secure communication between the access point and the second device is within a home area network.
